(19) United States
(12) Patent Application Publication
(10) Pub. No.: US 2009/0080999 A1
(43) Pub. Date: Mar. 26, 2009

(54) TOOLLESS MECHANICAL FASTENER

(75) Inventor: Phillip Richard DUNN, Dublin, OH (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: LIEBERT CORPORATION, Columbus, OH (US)

(21) Appl. No.: 11/859,857

(22) Filed: Sep. 24, 2007

(51) Int. Cl. F16B 23/00; B23P 11/00

(52) U.S. Cl. 411/500; 29/525.11

(57) ABSTRACT

A method of mounting a removable component to a mounting structure, comprising aligning an opening in the removable component with an opening in a mounting structure; aligning a toolless mechanical fastener with at least one of the openings; inserting a portion of the toolless mechanical fastener device through the opening in the removable component and the opening the mounting structure, contacting a head of the toolless mechanical fastener with an outer surface of the removable component; rotating the toolless mechanical fastener in a predetermined direction to a coupling position at some angle relative to its insertion position, contacting portions of the base of the toolless mechanical fastener with an inner surface of the mounting structure, and deforming at least a portion of the base to couple the removable component to the removable component between the head and the base of the mechanical fastener.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to fastening devices; and more specifically related to toolless mechanical fasteners for securing one component to another.

2. Description of the Related Art

Fastening devices have long been used to mount removable components. For example, in the IT market, fastening devices have been used to mount removable components to server or network cabinets. Bolts, screws, and/or nuts have been utilized to mount these removable components. For example, Knurr's Front Panel Mounting Kit includes caged nuts, a plate, a countersunk screw and a rosette. These devices all require selecting the appropriate tool and then using the tool to mount removable components.

The inventions disclosed and taught herein are directed to a toolless mechanical fastener for mounting a removable component to a mounting structure.

### BRIEF SUMMARY OF THE INVENTION

A method of mounting a removable component to a mounting structure, comprising aligning an opening in the removable component with an opening in a mounting structure; aligning a toolless mechanical fastener with at least one of the openings; inserting a portion of the toolless mechanical fastener device through the opening in the removable component and the opening the mounting structure, contacting a head of the toolless mechanical fastener with an outer surface of the removable component; rotating the toolless mechanical fastener in a predetermined direction to a coupling position at some angle relative to its insertion position, contacting portions of the base of the toolless mechanical fastener with an inner surface of the mounting structure, and deforming at least a portion of the base to couple the removable component to the removable component between the head and the base of the mechanical fastener.

Further, Applicants have created a toolless mechanical fastener adapted to couple a removable component to a mounting structure, comprising a head; a substantially rectangular base substantially parallel bottom of the head, the base shaped with a first dimension longer than a second dimension measured in the plane substantially parallel to the bottom of the head, and adapted to rotate and couple into a mounting structure to couple the removable component and mounting structure; a shaft having a cross-sectional shape smaller than the first dimension of the base as measured across a plane parallel to the base and coupled at least partially between the head and the base.

### BRIEF DESCRIPTION OF THE SEVERAL VIEWS OF THE DRAWINGS

FIG. 1 illustrates a front view of the an exemplary toolless mechanical fastener installed on a mounting structure in accordance with certain teachings of the present invention.

FIG. 2 illustrates the perspective view showing the bottom of a second toolless mechanical fastener device in accordance with certain teaching of the present invention.

FIG. 3 illustrates a side view of the fastening device of FIG. 2.

FIG. 4 illustrates the top view of the fastening device of FIG. 2.

FIG. 5 illustrates the side view of the fastening device of FIG. 2.

FIG. 6 illustrates the top sectional view of a toolless mechanical fastener in a accordance with certain teachings of the present invention.

FIG. 7 illustrates the top sectional view of a toolless mechanical fastener in a accordance with certain teachings of the present invention.

FIG. 8 illustrates the top perspective view of the toolless mechanical fastener installed on the mounting cabinet mounting a device.

FIG. 9 illustrates a perspective view showing the front and side of a third embodiment of the toolless mechanical fastener in accordance with certain teaching of the present invention.

FIG. 10 illustrates perspective view showing the front and side of a fourth toolless mechanical fastener in accordance with certain teaching of the present invention.

FIG. 11 illustrates a front view of a toolless mechanical fastener in accordance with certain teachings of the present invention.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created a method of mounting a removable component to a mounting structure, comprising aligning an opening in the removable component with an opening in a mounting structure; aligning a toolless mechanical fastener with at least one of the openings; inserting a portion of the toolless mechanical fastener device through the opening in the removable component and the opening the mounting structure, contacting a head of the toolless mechanical fastener with an outer surface of the removable component; rotating the toolless mechanical fastener in a predetermined direction to a coupling position at some angle relative to its insertion position, contacting portions of the base of the toolless mechanical fastener with an inner surface of the mounting structure, and deforming at least a portion of the base to couple the removable component to the removable component between the head and the base of the mechanical fastener.

Further, Applicants have created a toolless mechanical fastener adapted to couple a removable component to a mounting structure, comprising a head; a substantially rectangular base substantially parallel bottom of the head, the base shaped with a first dimension longer than a second dimension measured in the plane substantially parallel to the bottom of the head, and adapted to rotate and couple into a mounting structure to couple the removable component and mounting structure; a shaft having a cross-sectional shape smaller than the first dimension of the base as measured across a plane parallel to the base and coupled at least partially between the head and the base.

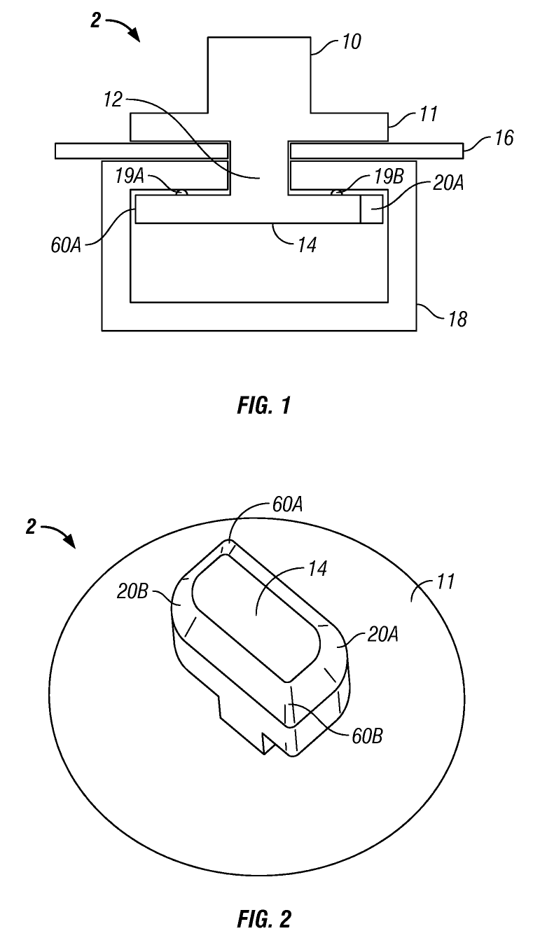

FIG. 1 is an illustration a front view of the an exemplary toolless mechanical fastener in accordance with certain teachings of the present invention. FIG. 1 illustrates an exemplary toolless mechanical fastener 2 mounting a removable component 16 to a mounting structure 18. The toolless mechanical fastener 2 includes a head 10, shaft 12, coupled to the head, and base 14 coupled to the shaft 12. The term “coupled,” “coupling,” and like terms used herein relative to the toolless mechanical fastener includes any method or devices for securing, bonding, fastening, attaching, engaging, joining, inserting therein, or forming on, in or with other associated members as an integral component or not. The toolless mechanical fastener can be made from any number of materials. In the exemplary embodiment the toolless mechanical fastener is made from injection molded plastic. The material would ideally allow for elastic deformation or recoverable deformation. Preferably, the head 14 and shaft 12 would be made of material that would allow elastic deformation or recoverable deformation.

In further embodiments, the toolless mechanical fastener can be made fully or partially from a conductive material. For example, the toolless mechanical fastener could be made from injection molded plastic with a conductive implant that allows for conductivity between the removable component and the mounting component. For example, conductive implant could run from the head 10 through the shaft 12 to the base 14. In the exemplary embodiment the material of the toolless mechanical fastener would compress or conform to the removable component 16 and mounting structure 18 to create a tight engaging fit. One exemplary embodiment is shown in FIG. 11. The conductive material 110A and 110B (collectively 110) routed from the head 10 through the shaft 12 to the top of the base 14. The conductive material 110 may be routed in any fashion within the toolless mechanical fastener 2 to create the necessary conductive properties.

The head 10 can be used as a gripping device. The head 10 gives the user the ability to rotate the toolless mechanical fastener with the goal of engaging and releasing the toolless mechanical fastener. The shape of the head 10 may be any shape that permits gripping or turning by a human hand. The head 10 can include additional features to assist in gripping or reduce slippage of the toolless mechanical fastener, such as gripping ribs or a textured surface. The head 10 includes a lip 11 with a dimension greater than the dimension of the opening in the mounting structure 18. The lip is used to engage and secure the removable component 16 to the mounting structure 18. The head 10 can include dimples (not shown) on the base of the lip 11. The term “dimples” is defined broadly and includes any projection at any angle to the contacting surface of the particular member coupled with the projection. The dimples aid in securing the toolless mechanical fastener to one or more removable component 16 and/or the mounting structure 18. The dimples can be cammed or sloped to allow for a tighter engaging fit and to minimize rotation in one direction. The dimples with or without cammed edges may also be added to any of the embodiments described, such as the base 14. FIG. 1 shows one exemplary configuration of two dimples 19A and 19B on the top surface of the base 10 of the toolless mechanical fastener 2.

The shaft 12 is designed to connect the head 10 and the base 14. The shaft 12 may take on any number of shapes. The shaft 12 has dimensions substantially equal to or less than the dimension of the inner cavity of the mounting structure 18 to create a tight fit. Further, the shaft 12 may be cammed to create a tight engaging fit between the opening of the mounting structure 18 and to minimize rotation in one direction. The cammed edges may also be added to any of the embodiments described, such as the base 14, which is shown in FIG. 2. The cammed edges may be made of a material that allows elastic deformation or recoverable deformation to lock in the toolless mechanical fastener and prevent rotation.

The base 14 is designed to engage the removable component to the mounting structure by creating a tight engaging fit between the removable component 16 and mounting structure 18 by engaging into the cavity of the mounting structure 18. The base 14 is designed to mount and engage the removable component 16 to the mounting structure 18. The base 14 can take on any number of shapes. Advantageously, the shape of the minor dimension of the base 14 is equal to or smaller than the opening of the mounting structure 18. This allows the base 14 of the toolless mechanical faster 2 to fit into the mounting structure 18 through the opening in the mounting structure 18. The shape of the major dimension of the base 14 is larger than the opening of the mounting structure 18 and is slightly larger or less than the cavity of the mounting structure 18. Ideally, the major dimension of the base 14 is slightly larger than the cavity of the mounting structure 18 to allow for a tight engaging fit. Due to the elastic deformation or recoverable deformation of the toolless mechanical fastener 2, the major dimension of the base 14 may be slightly larger than the cavity of the mounting structure 18 based on material property to allow recoverable deformation. Unremovability may be allowed but not preferred. Because of these dimensions, the base 14 is able to enter the opening of mounting structure 18 when its major dimension is aligned with the major dimension of the mounting structure 18.

To engage the toolless mechanical fastener, the base 14 is rotated, greater than zero degrees but less than 180 degrees, such as 90 degrees, so that its major dimension is substantially perpendicular to the major dimension of the opening of the mounting structure 18 thus coupling the removable component 18 and toolless mechanical fastener 2 into place. To decouple the removable component 16 and the toolless mechanical fastener 18, the toolless mechanical fastener 10 is rotated by some angle to realign the major dimension of the base 14 with the major dimension of the mounting structure 18 and then removed. The base 14 or any other surface of the toolless mechanical fastener can include dimples 19 to create a tight fit. These dimples would be made of a material that allows for elastic deformation or recoverable deformation. The dimples creates a tight clamping force. Further the dimples may be cammed to further lock in the toolless mechanical fastener and prevent rotation.

Preferably, the base 10 can be cammed or sloped to allow for a tighter engaging fit and to minimize rotation in one direction. One exemplary configuration is shown in FIG. 2. Cammed edges 20A and 20B (collectively 20) on opposite corners of the side edge of the base 14 of the toolless mechanical fastener allow the base 14 to tightly fit into the mounting structure 18 and minimize rotation in one direction. The cammed edges may be made of a material that allows elastic deformation or recoverable deformation to lock in the toolless mechanical fastener and prevent rotation. In the exemplary embodiment, the major dimension is substantially equal to the cavity dimension to create a tight engaging fit. When the toolless mechanical fastener 2 is rotated, the cammed edges initially have minimum contact and minimum deformation. As the toolless mechanical fastener 2 is rotated into its coupling position, the contact increases and the deformation increases, creating a tight engaging fit thus engaging the removable component to the mounting structure. Further, in the exemplary embodiment, the base 14 has a T-shape similar to the shape of the mounting structure 18.

The removable component 16 can be any removable component that has an opening or hole that can be used to mount the removable component 16. For example, in the IT environment, EIA rails, Power strips, power strip brackets or other panels in a server or network cabinet or in the power tools environment, the guides on a power saw table.

The mounting structure 18 typically includes structures, such as, but not limited to, openings, grooves, cavities, or canals for receiving fasteners to mount removable components. One exemplary embodiment would be a T-Slot rail or rack. For example, the Knurr Miracel® cabinet contains such T-Slot rails for mounting removable components. Another embodiment would include the rails on a table saw. The toolless mechanical fastener disclosed could be used to engage and/or lock down the rails to position the guides on a table saw. The slots could come in any number of sizes.

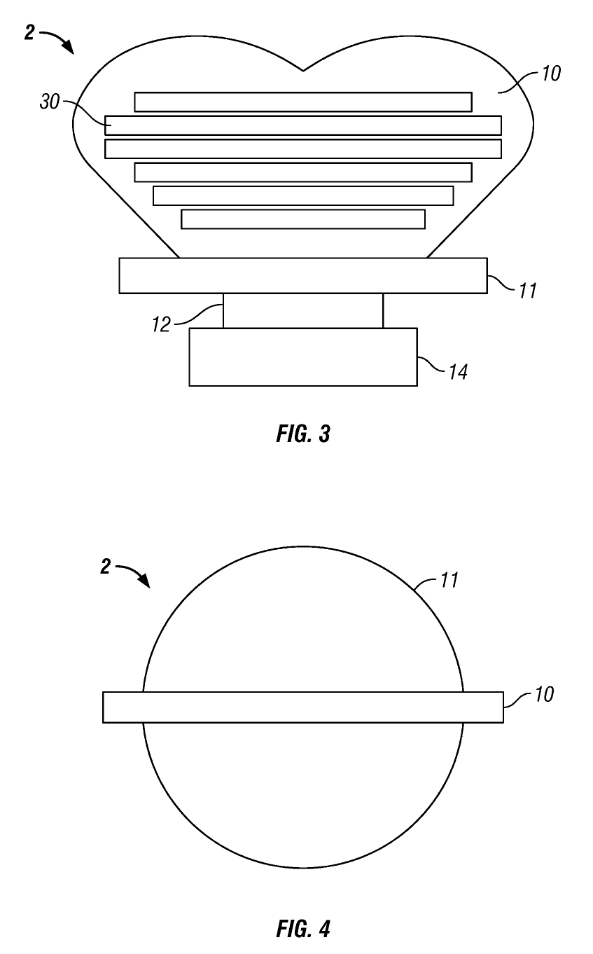

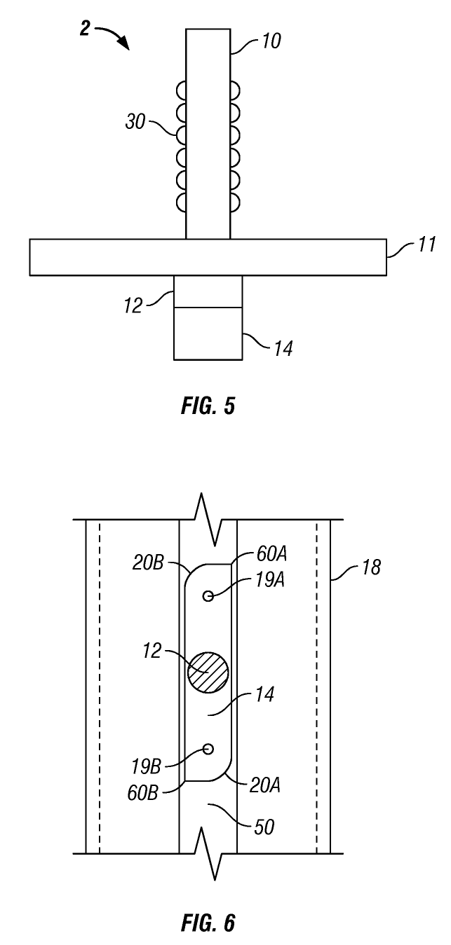

FIGS. 3-5 illustrate other views of the fastening device of FIG. 2. FIG. 3 illustrates the front of a second exemplary toolless mechanical fastener 2. The toolless mechanical fastener 2 includes a head 10, shaft 12, coupled to the head, and base 14, coupled to the shaft 12. This embodiment includes a head 10 in a different shape that in FIG. 1 and includes gripping ribs 30. As stated above, the gripping ribs 30 can come in any shape or form. The gripping ribs 30 are used to assist the user in rotating the toolless mechanical fastener 2. As was described above, the shaft 12 and the base 14 may include cammed or rounded edges to allow for a tighter engaging fit and to minimize rotation in one direction. Further, the lip 11 of the head 10 or the base 14 can include dimples to provide a tighter engaging fit. FIG. 4 illustrates the top view of a second exemplary toolless mechanical fastener 2. FIG. 5 illustrates a side view of a second exemplary toolless mechanical fastener 2.

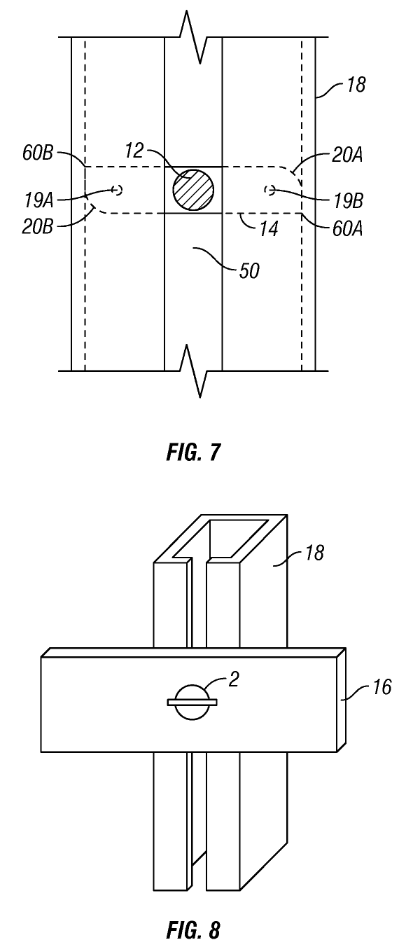

FIG. 6 illustrates a top sectional view of a toolless mechanical fastener in accordance with certain teachings of the present invention. FIG. 6 illustrates how the base 14 toolless mechanical fastener 2 is initially inserted into the cavity 50 of the mounting structure 18 (the head 10 and removable component 16 are not shown). After it is inserted into the cavity 50, the toolless mechanical fastener will be rotated zero to 180 degrees, such as 90 degrees, to create a tight engaging fit as is illustrated in FIG. 7.

FIG. 7 illustrates a top sectional view of a toolless mechanical fastener in accordance with certain teachings of the present invention. FIG. 7 illustrates how the base 10 or other elements of the toolless mechanical fastener can be cammed or sloped to allow for a tighter engaging fit and to minimize rotation in one direction. The toolless mechanical fastener of FIG. 6 is shown in an engaged position inside the cavity 50 of the mounting structure 18. Because the toolless mechanical fastener is made from a material that ideally would allow for elastic deformation or recoverable deformation the cammed edges 20A and 20B (collectively 20) allows a tight engaging fit and minimizes the rotation in the one direction (counterclockwise direction in this embodiment). The base 14 ideally would have a major dimension slightly larger than the cavity of the mounting structure 18 to create the ideal tight engaging fit. The recoverable deformation of the material would allow the base to engage without losing its structure with tight engaging fit. The non-cammed edges 60A and 60B would then prevent the device from rotating in the reverse direction. The dimples of the base 19A and 19B may also be cammed. This would also create a tight engaging fit and minimize the rotation in one direction.

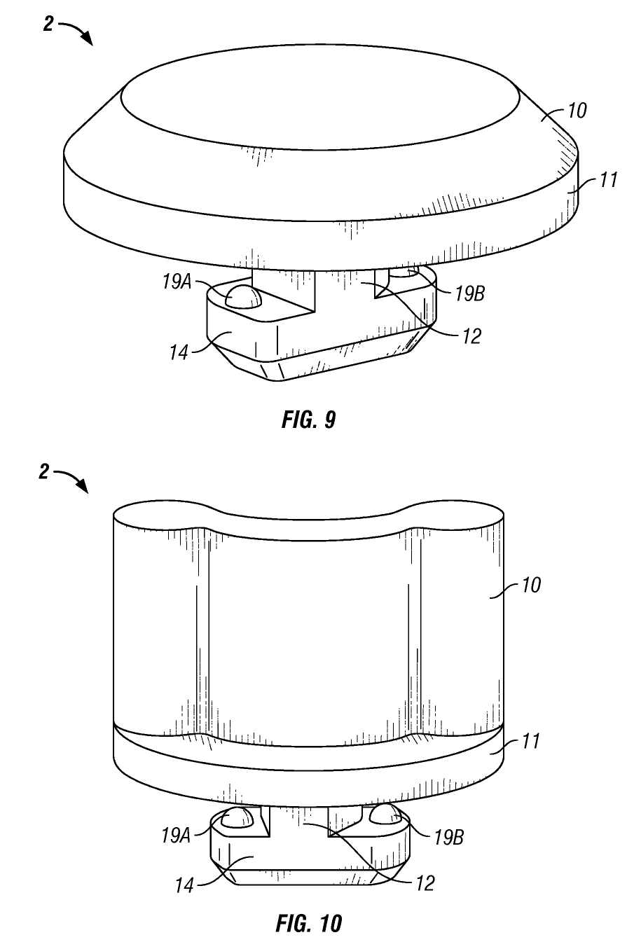

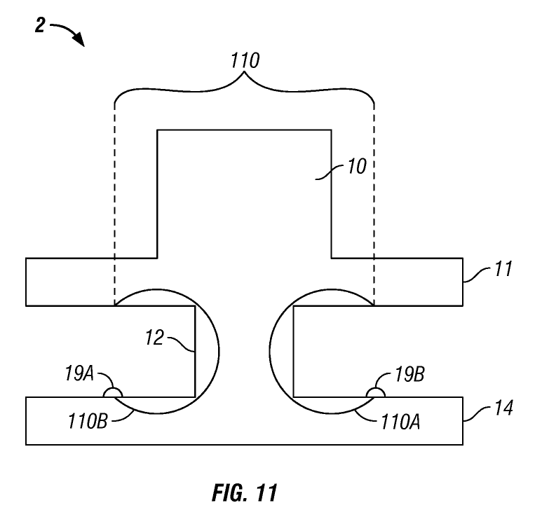

FIG. 8 is top perspective view of the toolless mechanical fastener installed on the mounting cabinet mounting a device. FIG. 9 illustrates perspective view showing the front and side of a third embodiment of the toolless mechanical fastener in accordance with certain teaching of the present invention. FIG. 10 illustrates perspective view showing the front and side of a fourth toolless mechanical fastener in accordance with certain teaching of the present invention.

For vertical mounting structures with vertical openings, grooves, t-slots, canals, or other opening, it is preferred that the toolless mechanical fastener not carry or support the load the removable component. Other structures, typically on the removable component, are intended and used to transmit the load of the removable component.

Other and further embodiments utilizing one or more aspects of the inventions described above can be devised without departing from the spirit of Applicant's invention. Further, the various methods and embodiments of the toolless mechanical fastener can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A method of mounting a removable component to a mounting structure, comprising:
aligning an opening in the removable component with an opening in a mounting structure;
aligning a toolless mechanical fastener with at least one of the openings;
inserting a portion of the toolless mechanical fastener device through the opening in the removable component and the opening the mounting structure,
contacting a head of the toolless mechanical fastener with an outer surface of the removable component;
rotating the toolless mechanical fastener in a predetermined direction to a coupling position at some angle relative to its insertion position, contacting portions of the base of the toolless mechanical fastener with an inner surface of the mounting structure, and
deforming at least a portion of the base to couple the removable component to the removable component between the head and the base of the mechanical fastener.

2. The method of claim 1, whereby the base portion of the toolless mechanical fastener is cammed.

3. The method of claim 1, whereby the tooless mechanical fastener comprises dimples.

4. The method of claim 3, whereby the dimples are cammed.

5. The method of claim 1, further comprising engaging a gripping device to effect the rotation of the toolless mechanical fastener.

6. The method of claim 1, further comprising resisting rotation of the toolless mechanical faster contrary to predetermined rotation direction.

7. The method of claim 1, wherein the angle relative to the insertion position is greater than zero and less than 180 degrees from the insertion position.

8. A toolless mechanical fastener adapted to couple a removable component to a mounting structure, comprising:
a head;
a substantially rectangular base substantially parallel bottom of the head, the base shaped with a first dimension longer than a second dimension measured in the plane substantially parallel to the bottom of the head,
and adapted to rotate and couple into a mounting structure to couple the removable component and mounting structure;
a shaft having a cross-sectional shape smaller than the first dimension of the base as measured across a plane parallel to the base and coupled at least partially between the head and the base.

9. The toolless mechanical fastener of claim 8, wherein the head further comprising a gripping member, adapted to rotate the toolless mechanical fastener, and a ridge, adapted to secure a first side of a removable device;

10. The toolless mechanical fastener of claim 8, further comprising dimples coupled to a contacting surface of the shank, base, head, or a combination thereof.

11. The toolless mechanical fastener of claim 8, wherein the base includes cammed edges.

12. The toolless mechanical fastener of claim 8, wherein the shaft includes cammed edges.

13. The toolless mechanical faster of claim 10, wherein the dimples include cammed edges.
